(19) United States
(12) Patent Application Publication
(10) Pub. No.: US 2010/0257476 A1
(43) Pub. Date: Oct. 7, 2010

(54) SYSTEM FOR THE VISUAL DISPLAY OF CLEAVING PROCESS DATA IN MEAT PROCESSING

(76) Inventor: Peter Schimitzek, Geilenkirchen (DE)

Correspondence Address: MICHAEL J. STRIKER, 103 EAST NECK ROAD, HUNTINGTON, NY, 11743, US

(21) Appl. No.: 12/740,259

(22) PCT Filed: Oct. 2, 2008
(86) PCT No.: PCT/DE2008/001631

§ 371 Date: Apr. 28, 2010

(30) Foreign Application Priority Data
Nov. 3, 2007 (DE) 20 2007 015 297.3

(51) Int. Cl. G06F 3/048

(52) U.S. Cl. 715/771

(57) ABSTRACT

A system for the visual display of cleaving process data for meat processing is described which renders it possible to precisely predict yields from individual parts after partitioning and to stipulate and map cutting guides for the purpose of providing specified yield data.

The system as an integral part of an ERP (Enterprise Resource Planning) system has an application (1), at least one database (2), suitable interfaces (3—3.1; 3.2; 3.3; 3.4; 3.5) to a user interface (5), visual display device, such as a monitor (6), printer (7) and link (8) to an ERP system installed in an EDP system.

The invention relates to a system for the visual display of cleaving process data, which is used in meat processing operations for specifying cutting guides.

Specifications of cutting guides for the partition of bodies of slaughtered animals are typically stored in the form of master data in a database which is an integral part of an ERP (Enterprise Resource Planning) system.

Stipulation of cleaving process specifications for slaughtered animals reveals the fact that in the case of identical starting products, such as slaughtered animal halves of one class, various yields from the individual parts result.

The specific class, different quality and cutting guide produce continuously varying specifications for desired yields which have to be used for the purpose of controlling the yield from the individual parts as a result of the cleaving and partitioning process in the desired/actual comparison.

A master data-related desired specification of cutting guides for all physiologically induced deviations leads to a cleaving and partitioning process specification tree which expands towards infinity.

By reason of the diversity, these master data can no longer be maintained.

In general, new master data are applied to a characteristic of the respective type of slaughtered animal and cutting guide which is an average at the time of generation.

The data are typically presented in a dynamic cleaving and partitioning process tree with a display of the specification data, wherein these data are only sporadically maintained, and therefore reflect the current cleaving and partitioning process to a limited extent only.

The prior art discloses systems for the automatic partitioning of bodies of slaughtered animals, in which cutting positions are stipulated on the basis of anatomical values stored in a central processing unit of an EDP system and are used for positioning cutting members.

Yields from individual parts which are achieved or are to be achieved are scarcely incorporated into the position of the cutting lines during coarse partitioning.

Coarse partitioning is followed by manual partitioning into individual parts.

In this case, the cut is typically guided according to the individual physiological characteristics of the body of the slaughtered animal or parts thereof.

In general, the achieved yields from individual parts are determined and recorded during the process of partitioning the body of the slaughtered animal.

The market value is then determined from these yields from the individual parts.

The bodies of slaughtered animals can also be partitioned in such a manner that the yields to be achieved are optimised by varied positions of the cutting lines of the basic cuts, wherein, however, the optimum market value of the individual parts is not always achieved.

This type of method, by which the yield is to optimised during slaughter is described e.g. in document DE 25 42 247 A1 for pig processing.

In order to produce a part which is favourable for the current market, main points of separation lines are established according to the desired weight between individual basic cuts on the respective animal body with the aid of a mathematical model on the basis of regression calculations, so that each hog body is cleaved in such a manner that the ham and loin pieces which have been cut out possess the greatest market value.

The solution described in this document renders it possible to optimise only the yield in relation to specific parts of the animal body to be partitioned.

Statements relating to the entire yield from the individual parts of a body of a slaughtered animal or specifications of cutting guides for supplying customers according to requirements cannot be provided.

The object of the invention is to develop a system for the visual display of cleaving process data for meat processing which renders it possible to predict yields from individual parts after partitioning and to stipulate and map cutting guides for the purpose of providing specified yield data.

The object is achieved by the features stated in claim 1. Preferred developments are provided in the subordinate claims.

An inventive system for the visual display of cleaving process data has an application having at least one database, suitable interfaces to an ERP system, data management device, visual display device, such as a display screen, user interface and printer.

Partitioning plans for halves of slaughtered animal bodies with cutting guides in a tree structure are stored in the database.

On the basis of a half of a slaughtered animal body, all of the necessary and possible partial steps of partitioning into the individual parts with the cutting guides thereof and with the allocation of their weight proportions are presented graphically and optionally with a verbal description as files arranged in a tree structure, wherein the weight proportions of the individual parts were ascertained in a known manner using stochastic methods, with data of yields from individual parts acquired during a sufficient number of partitioning processes.

The data relating to individual slaughtered animals and halves thereof, such as mass/weight, class and quality, are stored in the data management device.

When a partitioning plan is called up by a user, it is graphically displayed on the display screen.

The view within the tree structure can be called up from any node point of the tree structure which can be freely selected by the user, wherein the display of the cleaving process with the cutting guides can be defined in all directions.

By incorporating the data of the individual slaughtered animal halves which are stored in the data management device, the weight proportions of the individual parts are displayed.

When weight proportions of specific individual parts are specified, classified halves of slaughtered animal bodies suitable for this purpose are automatically allocated and the partition plan with the most favourable cutting guides is displayed on the display screen.

The graphical illustration of the partitioning plan with the cutting guides can be output as a hardcopy for use at partitioning stations.

In order to monitor yield, after partitioning, desired yield specifications are consulted in the desired/actual comparison using stochastic methods, said desired yield specifications having been acquired with data acquired in a sufficient number of partitioning processes and relating to yields from individual parts by incorporating the class and quality of a slaughtered animal and the cutting guide.

On the other hand, by incorporating the evaluation of data of yield results from a sufficient number of earlier partitions of classified bodies of slaughtered animals or the halves thereof, the expected yields of the individual parts can be predicted and by reference to current specific yield results can be adapted and displayed in a continuously automatic manner by means of the operative connection of the database to the data management device.

Physiological changes on account of breeds or other causes, as well as seasonally governed fluctuations in the quality of the bodies of slaughtered animals are thus also incorporated into the specification calculation of the yields and the resulting display of the specific partitioning plan and facilitate an improved economic and operational evaluation of cleaving processes.

The dynamic adaption of the specification data for quantities of individual parts and the visual display as a graphical cleaving process tree facilitates a clear view of the cutting guide, the yield specifications and of all relevant result data in a tree structure.

The system for the visual display of cleaving process data is preferably an integral part of an ERP system, to which all of the data relating to the partitioning are made available and by coupling to modules of the ERP-system, production planning, storage and accounting procedures are carried out.

In particular, the advantages of the invention reside in the graphical display of the cutting guides to optimise partitioning, from large parts to partial pieces, whereby higher yields are achieved by alternative cutting guides.

When utilising the system, it is possible not only to optimise the yield but also to safeguard the supply of individual parts to customers according to their requirements.

The presence of optimum cutting guides means that cleaving process plans and cleaving process retrograde calculations to individual parts can be carried out in a manner related to the display.

Statements relating to the demand for specific individual parts for producing a specified quantity of an end product or the achievable quantity of an end product from the available quantity of individual parts can be derived from the illustrations in the cleaving process tree in conjunction with the associated data in relation to the masses of the individual parts.

Furthermore, the partitioning costs are reduced, as optimum cutting guides are available and displayed.

The system for the visual display of cleaving processes can be utilised for partitioning any types of slaughtered animals which are subjected to a classification.

It is also feasible to utilise the system in the production of any meat products, even sausage.

The invention will be explained in greater detail as an exemplified embodiment by reference to the drawings, in which

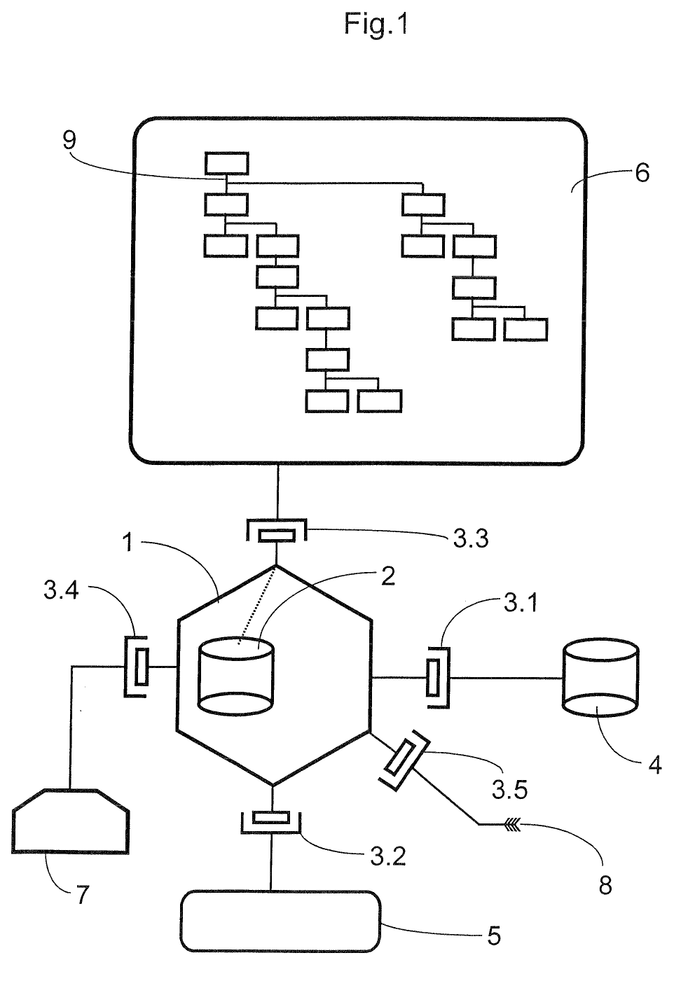

FIG. 1 shows a schematic illustration of the system for the visual display of cleaving process data, and

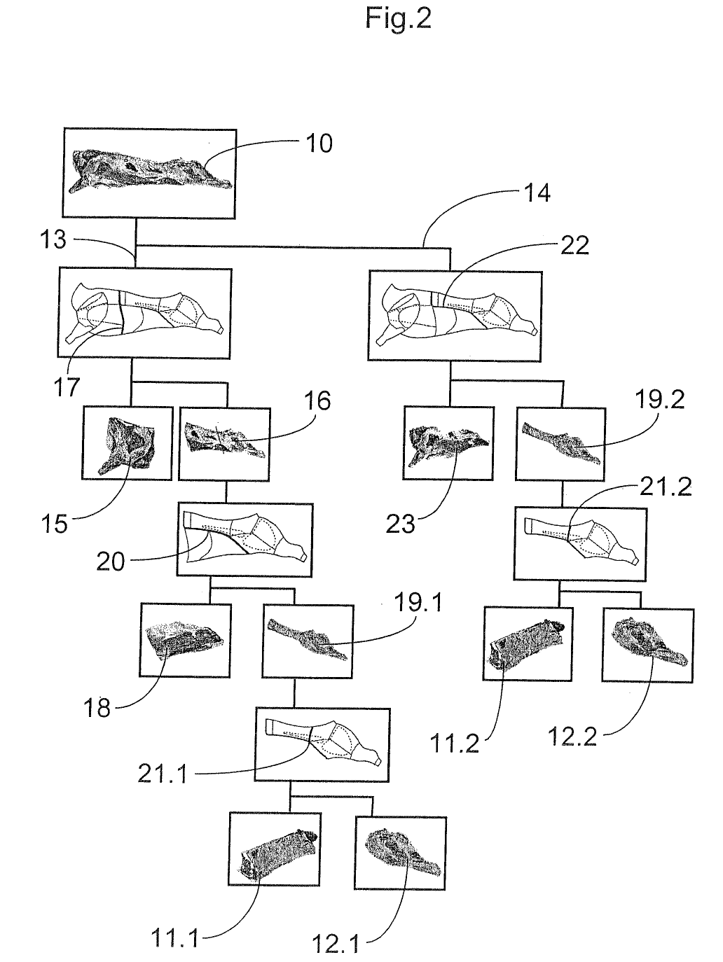

FIG. 2 shows an illustration of a partitioning tree with cutting guides.

As shown in FIG. 1, a system for the visual display of cleaving processes has an application 1, at least one database 2, suitable interfaces 3 (3.1; 3.2; 3.3; 3.4; 3.5) to a data management device 4, user interface 5, visual display device, such as a monitor 6, printer 7 and link 8 to an ERP system installed in an EDP system.

Stored in the database 2 are partitioning plans 9 which is [sic] graphically depicted in the form of a tree on the monitor 6 after interaction of a user with the application 1 by virtue of inputs made using the user interface 5.

The partitioning plans 9 include the illustration of the process steps for partitioning, starting from a slaughtered animal half through to the individual parts, wherein the illustrations in the partitioning tree have as their basis further data, such as weight/mass of the respective part.

As illustrated in FIG. 2 in principle using the example of a side of beef 10, partitioning into desired partial pieces, such as in this case sirloin 11 (11.1; 11.2) and haunch 12 (12.1; 12.2) can be carried out in the sequence of a first partitioning tree 13 or an alternative partitioning tree 14, wherein in accordance with the alternative partitioning tree 14 the outlay for the production of the sirloin 11.2 and the haunch 12.2 is substantially less than in accordance with the first partitioning tree 13.

According to the first partitioning tree 13, the side of beef 10 is partitioned into a forequarter 15 and a hindquarter 16, wherein a first cutting guide 17 is reproduced. The hindquarter 16 is partitioned further into a lobe 18 and a pistol 19 (19.1; 19.2).

A second cutting guide 20 is then depicted as a graphic.

A third cutting guide 21 (21.1; 21.2) which is required for partitioning the pistol 19.1 into the desired partial pieces of sirloin 11.1 and haunch 12.1 is again graphically illustrated.

During partitioning of the side of beef 10 in accordance with the alternative partitioning tree 14, it is partitioned in accordance with a graphically depicted alternative cutting guide 22 into a forequarter with a lobe 23 and the pistol 19.2.

The pistol 19.2 thus obtained must then be partitioned into the sirloin 11.2 and the haunch 12.2 merely by means of the likewise graphically depicted third cutting guide 21.2.

The weight of individually identifiable, classified sides of beef 10 obtained in the slaughtering process is stored in the data management device 4.

The data which relate to weights of individual parts, allocated for the respective class, and are ascertained stochastically from a sufficient number of partitions are likewise stored in the data management device 4.

As a result of an operative connection between the database 2 and the data management device 4, the expected yields from the individual parts of a slaughtered animal half are available [in] an updated form as a result of the incorporation of current specific yield results, [lacuna] the fluctuations of the quality of bodies of slaughtered animals.

The weights/masses for the individual partial pieces are arithmetically evaluated in accordance with the first partitioning tree 13 and the alternative partitioning tree 14 in each case on the basis of the aforementioned data.

The type of partitioning of the slaughtered animal half, in this case the side of beef 10, and the cutting guides 17, 20, 21 (21.1; 21.2) and 22 are utilised for “forward planning”, for determining the yield, the arithmetical evaluation of the weight of the partial pieces obtained during and after partitioning.

In order to fulfil specific customer orders with a specific quantity of partial pieces of a desired weight, like sirloin 11 (11.1; 11.2), “backward planning” can be implemented, wherein the cutting guide 17, 20, 21 (21.1; 21.2) and 22 is automatically calculated and displayed on the monitor 6 after specification of the yield showing the identifiable, classified slaughtered animal halves, such as sides of beef 10, which are to be selected and partitioned.

The partitioning plan which is to be implemented is output preferably in the form of the first partitioning tree 13, which is to be implemented specifically, or the alternative partitioning tree 14 as a hardcopy by the printer and is passed to the partitioning station.

### LIST OF REFERENCE NUMERALS USED

1 application

2 database

3 interfaces (3.1; 3.2; 3.3; 3.4; 3.5)

4 data management device

5 user interface

6 monitor

7 printer

8 link

9 partitioning plans

10 side of beef

11 sirloin (11.1; 11.2)

12 haunch (12.1; 12.2)

13 first partitioning tree

14 alternative partitioning tree

15 forequarter

16 hindquarter

17 first cutting guide

18 lobe

19 pistol (19.1; 19.2)

20 second cutting guide

21 third cutting guide (21.1; 21.2)

22 alternative cutting guide

23 forequarter with lobe

1. System for the visual display of cleaving process data in meat processing as an integral part of an ERP (Enterprise Resource Planning) system, characterised in that the system has an application (1), at least one database (2), suitable interfaces (3—3.1; 3.2; 3.3; 3.4; 3.5) to a user interface (5), visual display device, such as a monitor (6), printer (7) and link (8) to an ERP system installed in an EDP system.

2. System for the visual display of cleaving process data as claimed in claim 1, characterised in that stored in the database (2) are partitioning plans (9) for slaughtered animal bodies which are depicted on the monitor (6) in the manner of a tree after interaction of a user with the application (1).

3. System for the visual display of cleaving process data as claimed in claim 1, characterised in that in the data management device (4) the weight of individually identifiable, classified sides of beef (10) which are acquired in the slaughtering process are stored in the data management device 4.

4. System for the visual display of cleaving process data as claimed in claim 1, characterised in that the data which relate to weights of individual parts, allocated for the respective class of the slaughtered animal, and are ascertained stochastically from a sufficient number of partitions are stored in the data management device (4).

5. System for the visual display of cleaving process data as claimed in claim 1, characterised in that as a result of an operative connection between the database (2) and the data management device (4) the expected yields from the individual parts of a slaughtered animal half are available in updated form by the incorporation of current specific yield results, corresponding to the fluctuations in the quality of bodies of slaughtered animals.

6. System for the visual display of cleaving process data as claimed in claim 1, characterised in that the partitioning plans (9) includes the illustration of the process steps for partitioning, starting from a slaughtered animal half through to individual parts.

7. System for the visual display of cleaving process data as claimed in claim 1, characterised in that the partitioning plans (9) comprise a first partitioning tree (13) and an alternative partitioning tree (14).

8. System for the visual display of cleaving process data as claimed in claim 1, characterised in that cutting guide (17), (20), (21) and (22) are graphically illustrated in the partitioning tree (13; 14).

9. System for the visual display of cleaving process data as claimed in claim 1, characterised in that the illustrations in the partitioning tree (13; 14) have as their basis further data, such as weight/mass of the respective part.

10. System for the visual display of cleaving process data as claimed in claim 1, characterised in that the partitioning tree (13; 14) with the graphically depicted cutting guides (17), (20), (21) and (22) is provided as a hardcopy.
